(19) United States
(12) Patent Application Publication
(10) Pub. No.: US 2008/0055374 A1
(43) Pub. Date: Mar. 6, 2008

(54) Inkjet recording apparatus

(75) Inventor: Yasuko Yahiro, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/896,253

(22) Filed: Aug. 30, 2007

(30) Foreign Application Priority Data
Aug. 31, 2006 (JP) 2006-235906

(51) Int. Cl. B41J 2/175

(52) U.S. Cl. 347/85

(57) ABSTRACT

The inkjet recording apparatus has: an ink liquid container which stores ink containing a solvent-insoluble material dispersed in a solvent; an ink supply channel which is connected to the ink liquid container; and a pair of electrodes which is provided in the ink liquid container and/or the ink supply channel, and between which a voltage is applied so that a remaining amount of the ink in the ink liquid container and/or the ink supply channel is evaluated, wherein ratio of particles having a particle size equal to or greater than 100 nm in the ink is 5 volume percent or less.

### BACKGROUND OF THE INVENTION

1. Field of the Invention

The present invention relates to an inkjet recording apparatus, and more particularly, to an inkjet recording apparatus which determines the remaining amount of ink in an ink container and an ink supply channel, by applying a voltage between a pair of electrodes provided in the ink container and the ink supply channel.

2. Description of the Related Art

In an inkjet recording apparatus, the remaining amount of ink is determined in order to prevent the ink from running out during recording. Various methods have been proposed for determining the remaining amount of ink, such as a method which uses optical determination, a method which uses electrical determination, and a method which uses determination based on calculation, but of these, a method which determines the remaining amount of ink electrically is an excellent determination method from the viewpoint of the simplicity of composition.

The method of electrically determining the remaining amount of ink involves, for example, disposing a pair of electrodes inside the ink supply channel or the ink container, and determining the remaining amount of ink by determining a voltage change, a current change, or resistance change between the electrodes. For example, Japanese Patent Application Publication No. 2003-305862, Japanese Patent Application Publication No. 2005-59491, Japanese Patent Application Publication No. 2000-94712, Japanese Patent Application Publication No. 6-155761 and Japanese Patent Application Publication No. 10-17805 disclose apparatuses in which the remaining amount of ink is determined by determining the above-described values which change in accordance with the remaining amount of ink.

In recent years, there have been demands for improved functionality in terms of printing clarity, lightfastness, waterproofing characteristics, and the like, in inkjet recording apparatuses, and as a method for achieving these demands, it has been proposed to use an ink in which a solvent-insoluble material is dispersed in an ink, such as a pigment-based ink.

However, if ink of this kind is used in an inkjet recording apparatus which determines the remaining amount of ink electrically, then there is a possibility that, with the passage of time, the solvent-insoluble material, such as pigment, adheres to the electrodes and accurate determination becomes difficult.

### SUMMARY OF THE INVENTION

The present invention has been contrived in view of these circumstances, an object thereof being to provide an inkjet recording apparatus whereby the remaining amount of ink can be determined with good reliability over a long period of time.

In order to attain the aforementioned object, the present invention is directed to an inkjet recording apparatus comprising: an ink liquid container which stores ink containing a solvent-insoluble material dispersed in a solvent; an ink supply channel which is connected to the ink liquid container; and a pair of electrodes which is provided in the ink liquid container and/or the ink supply channel, and between which a voltage is applied so that a remaining amount of the ink in the ink liquid container and/or the ink supply channel is evaluated, wherein ratio of particles having a particle size equal to or greater than 100 nm in the ink is 5 volume percent or less.

In this aspect of the invention, even in a case where an ink comprising a solvent-insoluble material dispersed in a solvent, such as a pigment-based ink, is used in an inkjet recording apparatus which determines the remaining amount of ink electrically, it is possible to suppress the adherence of the solvent-insoluble material to the electrodes, and therefore the remaining amount of ink can be determined accurately even over a long period of use. In this aspect of the present invention, where it is stated that “ratio of particles having a particle size equal to or greater than 100 nm in the ink is 5 vol % (volume percent) or less”, this means that, of all of the particles contained in the ink, the ratio of particles having a particle size equal to or greater than 100 nm is 5 vol % or less.

In order to attain the aforementioned object, the present invention is also directed to an inkjet recording apparatus comprising: an ink liquid container which stores ink containing a solvent-insoluble material dispersed in a solvent; an ink supply channel which is connected to the ink liquid container; and a pair of electrodes which is provided in the ink liquid container and/or the ink supply channel, and between which a voltage is applied so that a remaining amount of the ink in the ink liquid container and/or the ink supply channel is evaluated, wherein ratio of particles having a particle size equal to or greater than 90 nm in the ink is 5 volume percentage or less.

In this aspect of the invention, even in a case where an ink comprising a solvent-insoluble material dispersed in a solvent, such as a pigment-based ink, is used in an inkjet recording apparatus which determines the remaining amount of ink electrically, it is possible to suppress the adherence of the solvent-insoluble material to the electrodes, and therefore the remaining amount of ink can be determined accurately even over a long period of use. In this aspect of the present invention, where it is stated that “ratio of particles having a particle size equal to or greater than 90 nm in the ink is 5 vol % or less”, this means that, of all of the particles contained in the ink, the ratio of particles having a particle size equal to or greater than 90 nm is 5 vol % or less.

Preferably, the solvent-insoluble material is pigment.

In this aspect of the invention, it is possible to determine the remaining amount of ink accurately over a long period of time, even if a so-called pigment-based ink is used.

Preferably, the solvent-insoluble material is latex.

In this aspect of the invention, it is possible to determine the remaining amount of ink accurately over a long period of time, even if the ink contains latex in order to improve the fixing properties on the media.

Preferably, electrical conductivity of the ink is equal to or greater than 1 mS/cm.

In this aspect of the invention, it is possible to determine the remaining amount of ink accurately, by setting the electrical conductivity of the ink to 1 mS/cm or above.

Preferably, the ink liquid container is a main ink container from which the ink is supplied to a subsidiary ink container via the ink supply channel; and the ink is supplied from the subsidiary ink container to a recording head.

Preferably, the ink liquid container is a subsidiary ink container to which the ink is supplied from a main ink container via the ink supply channel; and the ink is supplied from the subsidiary ink container to a recording head.

According to these aspects of the invention, in an inkjet recording apparatus which supplies ink by means of a so-called tube supply system, it is possible to determine the remaining amount of ink accurately. An inkjet recording apparatus which supplies ink by means of a tube supply system generally uses a main ink container having a large capacity, and therefore the electrodes in the main ink container, for example, are immersed in the ink for a long period of time; however, according to these aspects of the invention, it is possible to determine the remaining amount of ink accurately, even if the electrodes are immersed in the ink for a long period of time. Moreover, in an inkjet recording apparatus which employs a tube supply system of this kind, a high voltage is applied between the electrodes to determine the remaining amount of ink in the ink supply channel; however, according to these aspects of the invention, even in cases where a high voltage is applied between the electrodes, it is possible to suppress adherence of the solvent-insoluble material to the electrodes, and therefore it is possible to determine the remaining amount of ink accurately.

Preferably, the ink liquid container is a main ink container from which the ink is supplied to a subsidiary ink container via the ink supply channel; the ink is supplied from the subsidiary ink container to a recording head; and the pair of the electrodes is provided in the main ink container so that the remaining amount of the ink in the main ink container is evaluated.

According to this aspect of the invention, in an inkjet recording apparatus which supplies ink by means of a so-called tube supply system, it is possible to determine the remaining amount of ink in the main ink container.

Preferably, the ink liquid container is a subsidiary ink container to which the ink is supplied from a main ink container via the ink supply channel; the ink is supplied from the subsidiary ink container to a recording head; and the pair of the electrodes is provided in the subsidiary ink container so that the remaining amount of the ink in the subsidiary ink container is evaluated.

According to this aspect of the invention, in an inkjet recording apparatus which supplies ink by means of a so-called tube supply system, it is possible to determine the remaining amount of ink in the subsidiary ink container.

According to the present invention, in an inkjet recording apparatus which uses an ink containing a solvent-insoluble material dispersed in a solvent, such as a pigment-based ink, it is possible to determine the remaining amount of ink with good reliability, over a long period of time.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a plan diagram showing the general composition of an inkjet recording apparatus;

FIG. 2 is a schematic drawing of an ink supply system;

FIG. 3 is a general schematic drawing of a recording head;

FIG. 4 is a general schematic drawing of a remaining amount of ink determination apparatus;

FIGS. 5A to 5C are diagrams showing the relationship between the remaining amount of ink and the determination current waveform; and

FIG. 6 is a flowchart showing the sequence of processing of a remaining amount of ink determination operation and a filling operation.

### DETAILED DESCRIPTION OF THE PREFERRED EMBODIMENTS

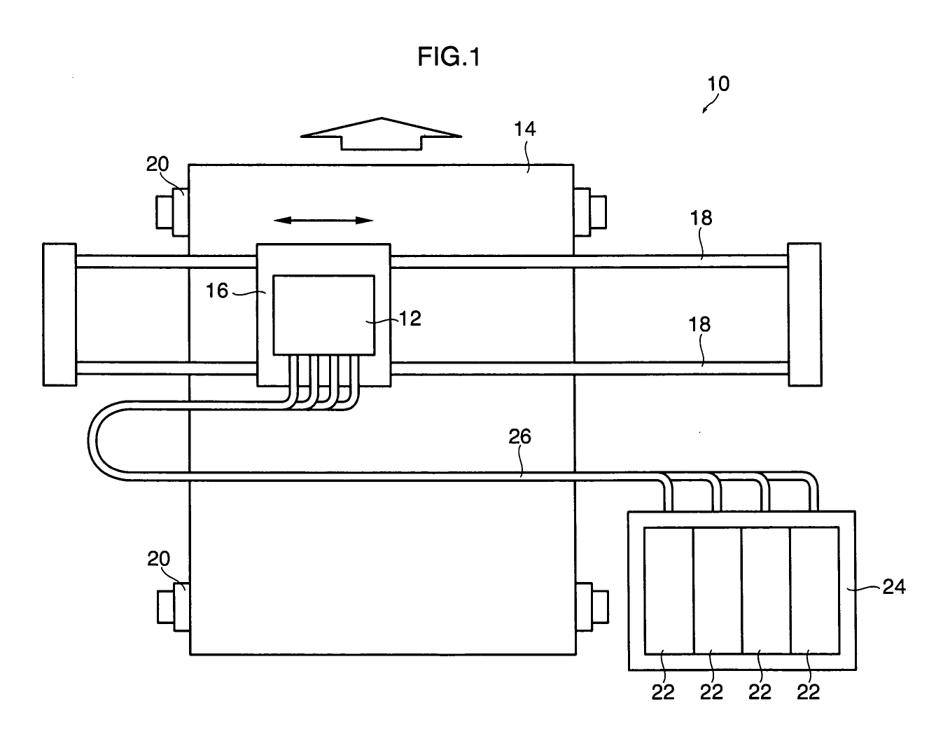

FIG. 1 is a plan diagram showing the approximate composition of an inkjet recording apparatus to which an embodiment of the present invention is applied.

As shown in FIG. 1, this inkjet recording apparatus 10 is a serial type inkjet recording apparatus which ejects ink selectively from a recording head 12 while repeating a reciprocal movement of the recording head 12 and conveyance of recording paper 14 based on a prescribed pitch, thereby recording text or images on the recording paper 14.

The recording head 12 is mounted detachably on a carriage 16, and the carriage 16 moves reciprocally along a single straight line by moving the carriage 16 along guide shafts 18.

On the other hand, the recording paper 14 is conveyed by conveyance rollers 20, and by means of these conveyance rollers 20 being driven to rotate by a drive device (not illustrated), the recording paper 14 is conveyed by a uniform pitch in a direction perpendicular to the direction of movement of the recording head 12.

In the inkjet recording apparatus 10 according to the present embodiment, the supply of ink to the recording head 12 is carried out by means of a tube supply method.

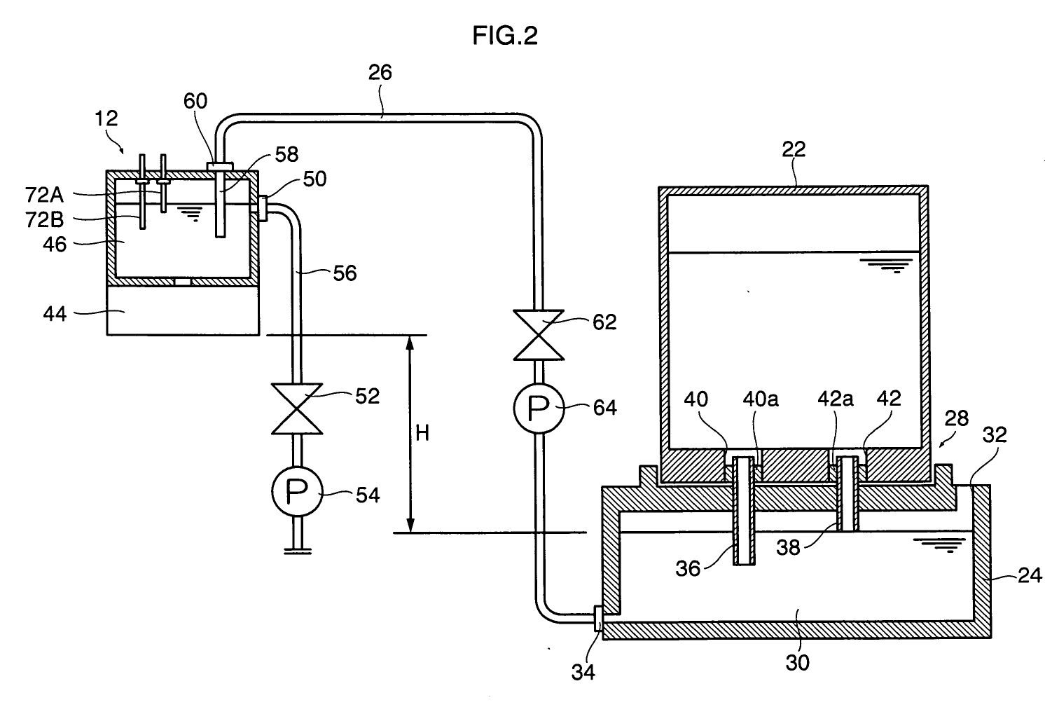

FIG. 2 is a general compositional diagram of an ink supply system in the inkjet recording apparatus 10 according to the present embodiment.

As shown in FIG. 2, the inks are accumulated in main ink containers 22 of large capacity and are supplied to a recording head 12 via ink supply tubes 26 from the ink supply unit 24 in which these main ink containers 22 are installed.

Each main ink container 22 is provided independently for each color of ink that is ejected from the recording head 12, the main ink containers 22 being installed separately on the ink supply unit 24.

Main tank installation units 28 for separately installing the main ink containers 22 are formed on top of the ink supply unit 24. Each main ink container 22 is installed detachably on the corresponding main ink container installation unit 28.

Ink chambers 30 are formed in the ink supply unit 24 so as to correspond respectively to the main ink container installation units 28.

Each ink chamber 30 is formed in a position below the corresponding main ink container installation unit 28, and an air port 32 for opening the interior of each ink chamber 30 to the air is formed in the ceiling of each ink chamber 30.

Furthermore, an ink supply tube connection port 34 for a connecting ink supply tube 26 to each ink chamber 30 is formed in the lower portion of a side face of each ink chamber 30. Each ink supply tube 26 is connected to the corresponding ink chamber 30 via this ink supply tube connection port 34.

Furthermore, each ink chamber 30 is also provided with a hollow ink supply needle 36 for introducing ink from the main ink container 22 installed in the main ink container installation unit 28 to the ink chamber 30, and an air introduction needle 38. These ink supply needle 36 and air introduction needle 38 are provided so as to pass vertically through the upper face of the ink chamber 30, and the upper end portion of each is provided so as to project by a prescribed amount from the main ink container installation unit 28. Furthermore, the ink supply needle 36 and the air introduction needle 38 are provided so that the lower end of the ink supply needle 36 is located below the lower end of the air introduction needle 38 by a prescribed amount.

When the main ink container 22 is installed on the main ink container installation unit 28, the ink inside the main ink container 22 flows out into the ink chamber 30, via the ink supply needle 36. In response to the ink which flows out into the ink chamber 30, air flows into the main ink container 22 via the air introduction needle 38, in such a manner that the internal pressure remains uniform. The outflow of ink from the main ink container 22 to the ink chamber 30 halts when the upper surface of the ink in the ink chamber 30 has reached a height equal to the lower end of the air introduction needle 38.

An ink supply port 40 and an air introduction port 42 are formed in the lower portion of the main ink container 22 so as to correspond to the ink supply needle 36 and the air introduction needle 38 respectively. Rubber stoppers 40a and 42a are inserted respectively into the ink supply port 40 and the air introduction port 42. When the main ink container 22 has been removed from the main ink container installation unit 28, the ink supply port 40 and the air introduction port 42 are sealed hermetically by the rubber stoppers 40a and 42a, in such a manner that the ink in same does not leak out.

On the other hand, when the main ink container 22 is installed on the main ink container installation unit 28, the ink supply needle 36 and the air introduction needle 38 provided with the main ink container installation unit 28 pass respectively through the rubber stopper 40a provided in the ink supply port 40 and the rubber stopper 42a provided in the air introduction port 42, thereby connecting the main ink container 22 with the ink chamber 30.

In this case, the rubber stopper 40a prevents ink from leaking from the gap between the ink supply needle 36 and the main ink container 22, and the rubber stopper 42a prevents ink from leaking from the gap between the air introduction needle 38 and the main ink container 22.

In this way, by installing the main ink container 22 on the main ink container installation unit 28, the main ink container 22 is connected with the ink chamber 30 via the ink supply needle 36 and the air introduction needle 38. When the main ink container 22 and the ink chamber 30 are connected together, as described above, the ink inside the main ink container 22 is supplied to the ink chamber 30 via the ink supply needle 36, and in order to compensate for the corresponding loss of pressure inside the main ink container 22, air is introduced into the main ink container 22 via the air introduction needle 38. The ink is supplied to the ink chamber 30 until reaching a position where the lower end of the air introduction needle 38 is submerged in the ink, and when the ink reaches that position, the supply of ink is halted and the ink chamber 30 is in an ink-filled state.

In this way, when the main ink container 22 is installed on the main ink container installation unit 28, the ink accumulated in the main ink container 22 is supplied automatically to the ink chamber 30, thereby filling the ink chamber 30 with ink.

Although not shown in the drawings, an installation determination device which determines the installation of each main ink container 22 is formed with each main ink container installation unit 28, in such a manner that the installation or non-installation of each main ink container 22 can be determined.

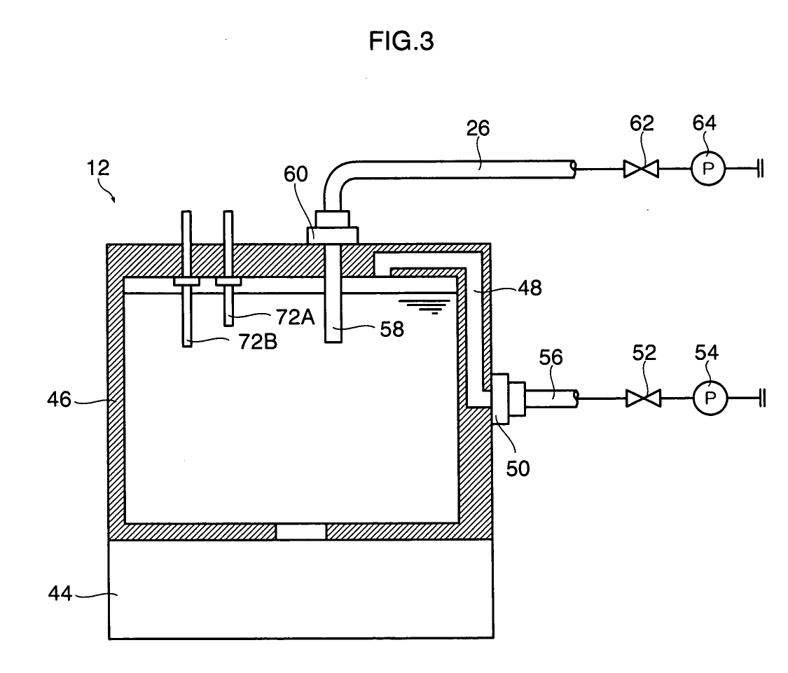

As shown in FIG. 3, the recording head 12 has an ink ejection unit 44 for ejecting ink. The ink ejection unit 44 comprises a plurality of nozzle rows for respectively ejecting inks of different colors, and energy generating devices for applying ink ejection energy to the nozzles which make up the nozzle rows. For the energy generating devices, it is possible to use electro-mechanical transducers such as piezo elements, electro-thermal transducers such as heating resistors, electromagnetic wave-mechanical transducers or electromagnetic wave-thermal transducers which convert electromagnetic waves, such as radio waves or a laser beam, into a mechanical vibration or heat, or the like. The energy generated by each energy generating device is applied to the ink of a nozzle, thereby causing an ink droplet to be ejected from the nozzle. The nozzle opening surface faces downwards, and the ink is ejected in a downward direction.

Subsidiary ink containers 46 for accumulating a prescribed quantity of ink are provided on the upper portion of the ink ejection unit 44. Each subsidiary ink container 46 is provided independently for each color of ink ejected from the ink ejection unit 44, and supplies ink to the corresponding nozzles via a filter (not illustrated).

A portion (or all) of each subsidiary ink container 46 is formed from an elastic material which is elastically deformable, in such a manner that the internal pressure of each subsidiary ink container 46 can be adjusted finely by applying a pushing or pulling force to the elastic portion (the portion made from the elastic material which is elastically deformable), by means of a pushing or pulling device (not illustrated).

If the subsidiary ink container 46 is made completely of a rigid material, then problems arise in that as the ink decreases, the pressure inside the subsidiary ink container 46 falls significantly. Furthermore, if serial scanning is carried out, then the ink in the subsidiary ink container 46 is caused to sway due to the applied acceleration, thus leading to problems of fluctuation in the pressure inside the subsidiary ink container 46.

However, by making a portion of the subsidiary ink container 46 from an elastic material, as in the subsidiary ink container 46 according to the present embodiment, it is possible for the volume of the subsidiary ink container 46 to reduce as the amount of ink decreases, thereby maintaining a uniform pressure inside the subsidiary ink container 46. Moreover, even if there is pressure variation due to the serial scanning action, since the elastic material deforms so as to absorb this variation, then it is possible to maintain a stable pressure in the subsidiary ink container 46.

Furthermore, an exhaust tube connection port 50 which is connected to the interior of each subsidiary ink container 46 via an evacuation channel 48 is provided in the side face of the subsidiary ink container 46. An exhaust tube 56 with an exhaust valve 52 and an evacuation pump 54 is connected to this exhaust tube connection port 50, and by driving the evacuation pump 54, it is possible to evacuate the air inside the subsidiary ink container 46.

Moreover, an ink supply tube connection port 60 which is connected to the interior of each subsidiary ink container 46 via an ink introduction channel 58 is provided in the upper portion of the subsidiary ink container 46. The ink supply tube 26 with the ink supply valve 62 and the ink supply pump 64 is connected to this ink supply tube connection port 60.

The supply of ink to each subsidiary ink container 46 is carried out in the following manner. In other words, firstly, the evacuation valve 52 is opened, and the interior of the subsidiary ink container 46 is set to atmospheric pressure. Thereupon, the elastic portion of the subsidiary ink container 46 is pushed by the pushing and pulling device, and in this state, the ink supply valve 62 is opened. Next, the ink supply pump 64 is driven, the ink in the ink chamber 30 is conveyed to the subsidiary ink container 46, and ink is filled into the subsidiary ink container 46. Thereupon, the evacuation valve 52 is closed, and ultimately, the subsidiary ink container 46 is pulled by the pushing and pulling device, and the interior of the subsidiary ink container 46 is set to a stable negative pressure.

The nozzles of the ink ejection unit 44 are open to the atmosphere, and furthermore, the nozzle opening surface is disposed facing in a downward direction. Consequently, the interior of the recording head 12 must be kept to a negative pressure in order to prevent ink from leaking out from the nozzles. If, on the other hand, the negative pressure is too great and air enters into the nozzles, then it may become impossible to eject ink from the nozzles.

In order to prevent the interior of the recording head 12 from assuming an excessive negative pressure state, in the inkjet recording apparatus 10 according to the present embodiment, a method is used which employs the water head differential, in addition to the method of applying a pulling force to the subsidiary ink container 46 as described above. In other words, the recording head 12 is disposed in such a manner that the position of the opening surface of the nozzles is at a height of H with respect to the liquid surface of the ink inside the ink chamber 30, thereby keeping the interior of the recording head 12 at a negative pressure corresponding to the water head differential of the height H.

By adopting a composition of this kind, then even if the evacuation valve 52 and the ink supply valve 62 are open during the supply of ink to the subsidiary ink container 46, a negative pressure is applied to the liquid surface of the ink inside the ink chamber 30, at the nozzle opening surface, and therefore ink does not leak out from the nozzles. Furthermore, it is prevented that, air may become incorporated into the nozzles due to the negative pressure becoming too great, which may occur in a method which generates a negative pressure by means of a pump. The interior of the nozzles are filled with ink and are held in a state where a meniscus is formed at the nozzle opening surface.

The ejection of ink from the nozzles is carried out by pushing the ink in the nozzles out by means of the energy generating devices. After the ejection of ink, new ink is supplied to the nozzles from the subsidiary ink containers 46, due to capillary action. During a recording operation, the tasks of ejecting ink from the nozzles and supplying ink from the subsidiary ink containers 46 are carried out repeatedly. Therefore, when the remaining amount of ink in the subsidiary ink container 46 has fallen below a prescribed amount, the ink refilling operation described above is carried out and ink is supplied from the main ink container 22 to the subsidiary ink container 46.

Here, the remaining amount of ink in each subsidiary ink container 46 is determined by means of a remaining amount of ink determination apparatus 70, and if the remaining amount of ink determined by this remaining amount of ink determination apparatus 70 has fallen below a prescribed amount, then ink is supplied from the main ink container 22 to the subsidiary ink container 46. The method of determining the remaining amount of ink by means of this remaining amount of ink determination apparatus 70 is described in detail later.

Since air gradually accumulates in each subsidiary ink container 46 of the recording head 12, with the passage of time, the evacuation valve 52 is opened periodically in order to evacuate the surplus air which has accumulated.

Furthermore, although not shown in the drawings, a restoration unit is provided in the inkjet recording apparatus 10 according to the present embodiment, whereby, if ink of increased viscosity becomes blocked inside the ink ejection unit, or if gas bubbles arise inside the ink, or the like, then these can be restored. This restoration unit is constituted, for example, by a cap which caps the nozzle opening surface of the recording head 12, and a suction pump, in such a manner that by forcibly suctioning the ink in the recording head 12 by means of the suction pump while the nozzle opening surface is capped by the cap, the ink of increased viscosity and the excess gas bubbles can be removed from the ink ejection unit.

As described above, in the inkjet recording apparatus 10 according to the present embodiment, the remaining amount of ink of the subsidiary ink container 46 is determined by the remaining amount of ink determination apparatus 70, and if the remaining amount of ink determined by the remaining amount of ink determination apparatus 70 falls below a prescribed amount, ink is supplied from the main ink container 22 to the subsidiary ink container 46.

Below, the composition of the remaining amount of ink determination apparatus 70 which determines the remaining amount of ink of each subsidiary ink container 46 is described.

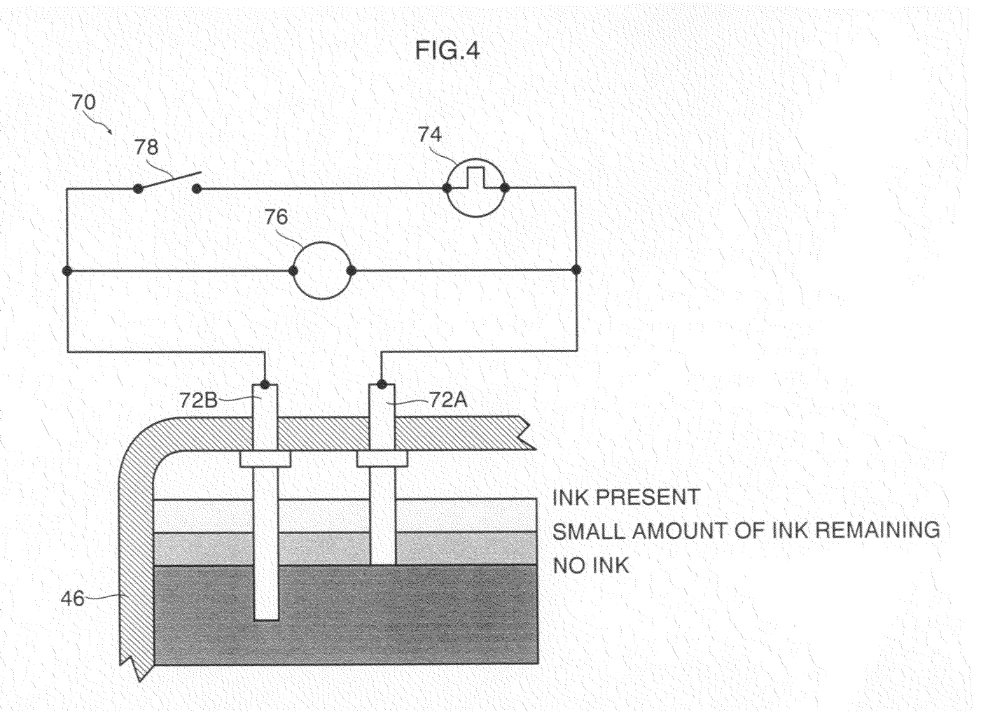

FIG. 4 is a general schematic drawing of the remaining amount of ink determination apparatus 70. As shown in FIG. 4, the remaining amount of ink determination apparatus 70 principally comprises: a first remaining amount of ink determination needle 72A and a second remaining amount of ink determination needle 72B which constitute a pair of electrodes; a voltage application apparatus 74 which applies a prescribed pulse voltage between the first remaining amount of ink determination needle 72A and the second remaining amount of ink determination needle 72B; a current meter 76 which determines the current flowing between the first remaining amount of ink determination needle 72A and the second remaining amount of ink determination needle 72B; and a switch 78. The overall operation is controlled by means of a control apparatus of the inkjet recording apparatus 10 (which is not shown).

The first remaining amount of ink determination needle 72A and the second remaining amount of ink determination needle 72B are formed in a circular rod shape from a material having conductivity (for example, iron, stainless steel, carbon, gold, silver, copper, platinum, manganese, nickel, or the like), and are disposed vertically inside the subsidiary ink container 46 at a prescribed interval apart. The upper ends of these needles are provided so as to project by a prescribed amount from the upper surface of the subsidiary ink container 46, and the lower ends thereof are provided inside the subsidiary ink container 46 in such a manner that the lower end of the second remaining amount of ink determination needle 72B is positioned below the lower end of the first remaining amount of ink determination needle 72A. In this way, by differentiating the positions of the lower ends of the first remaining amount of ink determination needle 72A and the second remaining amount of ink determination needle 72B, a marked differential is created between the current flowing when both remaining amount of ink determination needles are submerged in ink and the current flowing when only one of the remaining amount of ink determination needles is submerged in ink, and thus it is possible to achieve accurate determination of the remaining amount of ink.

Desirably, the materials of the first remaining amount of ink determination needle 72A and the second remaining amount of ink determination needle 72B are materials having high chemical stability, such as stainless steel, gold and platinum. By using these materials, it is possible to determine the remaining amount of ink more stably, irrespective of the properties of the ink liquid.

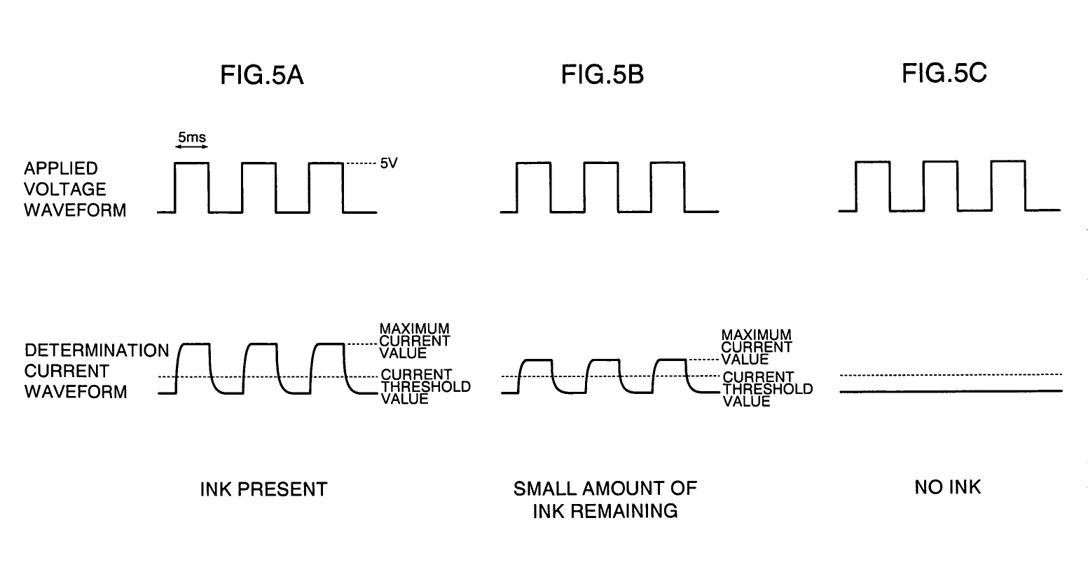

The voltage application apparatus 74 applies a prescribed pulse voltage between the first remaining amount of ink determination needle 72A and the second remaining amount of ink determination needle 72B. The current meter 76 determines the current flowing between the first remaining amount of ink determination needle 72A and the second remaining amount of ink determination needle 72B, and outputs the current value to the control apparatus. The control apparatus evaluates the remaining amount of ink on the basis of the current value acquired from this current meter 76, and executes a refilling operation of the ink as and when necessary. In other words, as shown in FIGS. 5A to 5C, if the maximum current value determined by the current meter 76 falls below a previously established threshold value, then it is judged that the ink has run out and an ink refilling operation is carried out.

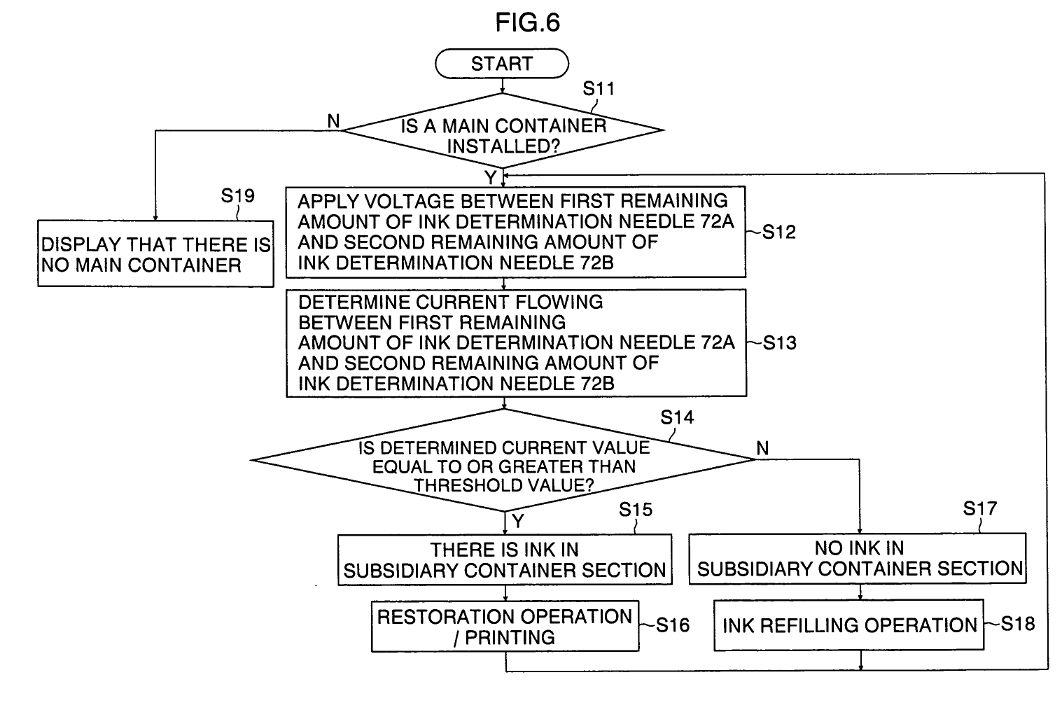

FIG. 6 is a flowchart showing the sequence of processing for determination of the remaining amount of ink and a refilling operation, which is implemented by the control apparatus of the inkjet recording apparatus 10.

As shown in FIG. 6, firstly, the control apparatus judges whether or not a main ink container 22 has been installed in the ink supply unit 24 (step S11). If it is judged that a main ink container 22 has not been installed in the ink supply unit 24, then the control apparatus displays an error message indicating that a main ink container has not been installed, on a monitor (not illustrated) which is provided in the inkjet recording apparatus 10 (step S19).

If, on the other hand, a main ink container 22 is installed in the ink supply unit 24, then a prescribed pulse voltage is applied between the first remaining amount of ink determination needle 72A and the second remaining amount of ink determination needle 72B via the voltage application apparatus 74 (step S12). The current flowing between the first remaining amount of ink determination needle 72A and the second remaining amount of ink determination needle 72B is determined by the current meter 76 (step S13), and this determination result is acquired.

The control apparatus compares the current value acquired from the current meter 76 with a previously established threshold value, and judges whether or not the current flowing between the first remaining amount of ink determination needle 72A and second remaining amount of ink determination needle 72B is equal to or greater than the threshold value (step S14). If the current is judged to be equal to or greater than the threshold value, then it is judged that there is ink inside the subsidiary ink container 46 (step S15), and a printing operation, and if necessary, a restoration operation, is carried out (step S 16).

If, on the other hand, it is judged that the current flowing between the first remaining amount of ink determination needle 72A and the second remaining amount of ink determination needle 72B has fallen below the threshold value, then it is judged that there is no ink inside the subsidiary ink container 46 (step S17), and an ink refilling operation is carried out (step S18).

Thereupon, the procedure returns again to step S12 and the processing described above is repeated.

In this way, in a case where the remaining amount of ink is determined electrically, then if an ink in which a solvent-insoluble material is dispersed in a solvent, such as a pigment-based ink, is used, the solvent-insoluble material such as pigment becomes attached to the electrodes with the passage of time, and it becomes difficult to achieve accurate determination.

Therefore, in the inkjet recording apparatus 10 according to the present embodiment, when an ink in which a solvent-insoluble material is dispersed in the solvent is used, the ratio of particles having a particle size of 100 nm or greater is not more than 5 vol % (which means that the ratio of particles having a particle size of 100 nm or greater is 5 vol % or lower of all the particles contained in the ink), and more desirably, the ratio of particles having a particle size of 90 nm or greater is not more than 5 vol % (which means that the ratio of particles having a particle size of 90 nm or greater is 5 vol % or lower of all the particles contained in the ink).

Consequently, even in a case where an ink comprising a solvent-insoluble material dispersed in the solvent, such as a pigment-based ink, is used in an inkjet recording apparatus which determines the remaining amount of ink electrically, it is possible to suppress the adherence of the solvent-insoluble material to the electrodes (the first remaining amount of ink determination needle 72A and the second remaining amount of ink determination needle 72B), and therefore the remaining amount of ink can be determined accurately even after a long period of use.

Desirably, the concentration of the solvent-insoluble material dispersed in the solvent is not less than 1 wt % and not more than 20 wt %, taking account of the viscosity that is suitable for ejection (20 mPa·s or lower). More desirably, the pigment concentration is not less than 4 wt %, in order to obtain good optical density in the image.

Furthermore, the surface tension of the ink is desirably not less than 20 mN/m and not more than 40 mN/m, taking account of ejection stability.

Furthermore, desirably, the electrical conductivity of the ink is not less than 1 mS/cm, in order that the remaining amount of ink can be determined with good accuracy by means of an electrical method.

Moreover, the solvent-insoluble material dispersed in the ink is principally pigment, but it may also be a fixing resin, or a plurality of other materials may be mixed into the ink.

It is desirable to use organic color pigments for the pigments. Examples of a cyan organic color pigment may include: C.I. Pigment Blue-1, C.I. Pigment Blue-2, C.I. Pigment Blue-3, C.I. Pigment Blue-15, C.I. Pigment Blue-15:2, C.I. Pigment Blue-15.3, C.I. Pigment Blue-15:4, C.I. Pigment Blue-16, C.I. Pigment Blue-22, and the like. Moreover, examples of a magenta organic color pigment may include: C.I. Pigment Red-5, C.I. Pigment Red-7, C.I. Pigment Red-12, C.I. Pigment Red-48, C.I. Pigment Red-48:1, C.I. Pigment Red-57, C.I. Pigment Red-112, C.I. Pigment Red-122, C.I. Pigment Red-123, C.I. Pigment Red-146, C.I. Pigment Red-168, C.I. Pigment Red-184, C.I. Pigment Red-202, C.I. Pigment Red-207, and the like. Furthermore, examples of a yellow pigment include C.I Pigment Yellow-12, C.I Pigment Yellow-13, C.I Pigment Yellow-14, C.I Pigment Yellow-16, C.I Pigment Yellow-17, C.I Pigment Yellow-74, C.I Pigment Yellow-83, C.I Pigment Yellow-93, C.I Pigment Yellow-95, C.I Pigment Yellow-97, C.I Pigment Yellow-98, C.I Pigment Yellow-114, and the like.

Furthermore, for the fixing resin, it is possible to use an acrylic resin, a urethane resin, a polyester resin, a vinyl resin, a styrene resin, or the like, but in order sufficiently to achieve the function of improving fixing properties, it is necessary to add a polymer of relatively high molecular weight, in a high concentration (1 wt % to 20 wt %). However, if it is sought to add the aforementioned materials by dissolving the materials in the liquid described above, then the ink acquires a high viscosity and the ejection characteristics decline. Therefore, in order to add a suitable material at a high density and to suppress increase in the viscosity, a device which adds the material in the form of a latex is valuable. Examples of a latex material include, for instance: an alkyl acrylate copolymer, a carboxy-modified SBR (styrene butadiene latex), SIR (styrene—isoprene latex), MBR (methylmethacrylate—butadiene latex), NBR (acrylonitrile—butadiene latex), and the like.

The glass transition point Tg of the latex has a significant effect during the fixing process, and desirably, it is equal to or greater than 50° C. and equal to or less than 120° C., in order to achieve both stability during storage at normal temperature and good fixing characteristics after heating.

Furthermore, the minimum film formation temperature MFT of the latex also has a significant effect during the fixing process, and in order to achieve satisfactory fixing at a low temperature, desirably, the MFT is not more than 100° C., and more desirably, not more than 50° C.

Furthermore, the present embodiment has been described with respect to an example where the present invention is applied to an inkjet recording apparatus which uses a tube supply system, but there are no particular restrictions on the ink supply system, provided that the inkjet recording apparatus is one which determines the remaining amount of ink electrically. For example, it is possible to apply the present invention similarly to an inkjet recording apparatus which employs a pit stop supply system (pit in supply system) or a cartridge supply system, or the like, in which case similarly beneficial effects can be achieved. Here, a pit stop supply system means a system in which a main ink container is provided separately from a recording head which comprises an internal ink chamber, and as and when necessary, the recording head is moved to the position of the main ink container and connected with same, and thereby ink is supplied to the ink chamber. A cartridge supply system means a system in which a cartridge filled with ink and a recording head are mounted on a carriage and the ink is supplied to the recording head from the cartridge.

Since a tube supply system involves a relatively long channel for ink, then an electrical determination method which is able to confirm the remaining amount of ink at each section over a broad range is particularly effective, and therefore the present invention which enables this electrical determination method to be implemented with greater reliability is particularly effective in such a tube supply system.

For example, in the present embodiment, the electrodes (the first remaining amount of ink determination needle 72A and the second remaining amount of ink determination needle 72B) are disposed inside a subsidiary ink container, and the remaining amount of ink inside this subsidiary ink container is determined, but it is also possible to adopt a composition where electrodes are disposed in the main ink container or the ink supply tube, and the remaining amount of ink in these may be determined. Moreover, it is also possible to adopt a composition in which electrodes are disposed in both the main ink container and the subsidiary ink container, in such a manner that the remaining amount of ink in both of these containers is determined. By determining the remaining amount of ink in both the main ink container and the subsidiary ink container, it is possible to determine the presence of ink in the main ink container, in the subsidiary ink container and in the ink supply tube.

Since the capacity of the subsidiary ink container is relatively small compared to the capacity of the main ink container, then the frequency of determination of the remaining amount of ink in the subsidiary ink container is high, and therefore the present invention, which enables accurate determination of the remaining amount of ink over a long period of time, is a particularly effective.

Moreover, when the remaining amount of ink in a main ink container is determined, it is also possible to make the ink supply needle 36 and the air introduction needle 38 function as electrodes. In other words, a composition is adopted in which a prescribed voltage is applied to the ink supply needle 36 and the air introduction needle 38, the current flowing between same is determined, and the remaining amount of ink inside the main ink container is determined accordingly. Consequently, there is no need to provide separate electrodes for determining the remaining amount of ink, and therefore the composition of the apparatus can be simplified.

Moreover, in the present embodiment, a case is described above in which the present invention is applied to an inkjet recording apparatus which comprises two types of ink container, namely, a main ink container and a subsidiary ink container, but there are no particular restrictions on the form of the ink container of which the remaining amount of ink is determined. The present invention may be applied equally to a case where the remaining amount of ink is determined in any mode of ink container, and similar beneficial effects can be obtained. Consequently, in an inkjet recording apparatus which comprises two ink containers, a main ink container and a subsidiary ink container, the same beneficial effects are obtained, whichever of the ink containers is subjected to determination of the remaining amount of ink, and consequently, in either case, it is possible to determine the remaining amount of ink accurately over a long period of time.

Furthermore, the present embodiment is described above with respect to an example where the present invention is applied to a serial type of inkjet recording apparatus which carries out a recording operation while moving a recording head, but there are no particular restrictions on the recording method, provided that the inkjet recording apparatus is one which determines the remaining amount of ink electrically. Consequently, it is possible to apply the present invention similarly to a line type of inkjet recording apparatus which carries out a recording operation by conveying the recording medium only, without moving the recording head, and in this case, similar beneficial effects can be obtained.

Moreover, in the present embodiment, a pulse voltage is applied to the pair of electrodes (the first remaining amount of ink determination needle 72A and the second remaining amount of ink determination needle 72B), and the peak value of the current flowing between these electrodes is determined, whereby the remaining amount of ink is determined, but the voltage applied between the pair of electrodes is not limited to this type of voltage. The remaining amount of ink can also be determined even if the applied voltage is a DC voltage, an AC voltage, or another voltage waveform. In the case of a DC voltage, electrical power is consumed at all times, whereas in the case of an AC voltage, the voltage value changes continuously, and therefore, in these cases, it is not easy to measure the change in the current. In view of this, it is desirable that a pulse voltage should be applied between the pair of electrodes in order to determine the remaining amount of ink.

Furthermore, the method of determining the remaining amount of ink is not limited to this. For example, it is possible to apply a DC voltage between a pair of electrodes, determine the rate of change of the current flowing between the electrodes, and determine the remaining amount of ink accordingly, and it is also possible to apply an AC voltage between a pair of electrodes, determine the waveform of the current flowing between the electrodes, and determine the remaining amount of ink accordingly. Moreover, rather than determining the remaining amount of ink by determining the current flowing between a pair of electrodes, it is possible to determine the remaining amount of ink by determining the resistance between the pair of electrodes, and it is also possible to determine the remaining amount of ink by determining the voltage arising when a particular current flows between the pair of electrodes. In other words, there are no particular restrictions on the concrete determination method, provided that the method is one which determines the remaining amount of ink electrically.

### PRACTICAL EXAMPLES

In an inkjet recording apparatus which determines the remaining amount of ink electrically, the residual amount of ink was determined while changing the average particle size of the solvent-insoluble material in the ink, the ratio of particles having a particle size of 100 nm or greater, the ratio of particles having a particle size of 90 nm or greater, and the voltage applied between the electrodes (determination voltage), and the change in the determination capability after one day and one week was investigated.

An inkjet recording apparatus based on a tube supply system was used as the inkjet recording apparatus, and similarly to the embodiment described above, the current flowing between the pair of electrodes was determined and the remaining amount of ink in the subsidiary ink container was determined accordingly (see FIG. 4).

Stainless steel having high chemical stability was used for the electrodes, and the distance between the electrodes was set to 1.0 cm. Moreover, the environmental temperature was set to 25° C., and a pulse voltage at 100 Hz and duty ratio of 1 was applied.

Furthermore, an ink having the following composition was used.

| | |
|---|---|
| Pigment C.I. Pigment Red-122 | 5 wt % |
| Acrylic latex (average particle size: 30 nm; Jurymer ET-410, | 5 wt % |
| made by Nihon Junyaku Co., Ltd.) | |
| Glycerine | 20 wt % |
| Diethylene glycol | 10 wt % |
| Olefin E1010 (made by Nisshin Chemical Industry Co., Ltd.) | 2 wt % |
| Deionized water | remainder |

Here, details of the method of manufacturing the ink used in the present example are described below.

Firstly, a ball mill, a sand mill, a beads mill, a high-pressure homogenizer, or an ultrasonic homogenizer, or the like, may be used in the method of dispersing the ink, but a method using an ultrasonic homogenizer is more appropriate as a method which enable mono-dispersion of fine particles to be achieved relatively effectively.

An ultrasonic homogenizer generates and extinguishes gas bubbles by means of a cavitation effect in a solution, due to ultrasonic waves, and it is possible to pulverize the large particles in the solution due to the impacts created by this effect. It is possible to adjust the average particle size and the content ratio of large particles, by adjusting the ultrasonic wave irradiation time, or the irradiation energy, or both the irradiation time and the irradiation energy.

For the dispersant, an ABC type block polymer comprising methacrylic acid (A)/benzyl methacrylate (B)/ethoxy triethylene glycol methacrylate (C) (A:B:C=13:4:10 (mol ratio)) was prepared. 30 g of polymer, 9 g of 45% aqueous solution of potassium hydroxide, and 261 g of deionized water were mixed together until a uniform mixture was obtained. 150 g of C.I. Pigment Red-122 and 550 g of deionized water were added to the polymer and mixed into same, and preliminary mixing was carried out by agitating for 30 minutes in a dispersion machine. Next, this preparatory mixture was introduced into a dual tank with an internal capacity of 2 liters, and while agitating with a dispersion blade and cooling by means of cooled water at 18° C., the mixture was subjected to batch irradiation for 30 minutes using an ultrasonic homogenizer US-1200T (made by NihonSeiki Kaisha Ltd.) with a 36-mm tip. In this operation, the amplitude of vibration was 28 μm and the energy density of the ultrasonic wave irradiation was 110 W/cm².

Acrylic latex (average particle size 30 nm; Jurymer ET-410, made by Nihon Junyaku Co., Ltd.) was added to the dispersion of pigment thus obtained, and glycerine, diethylene glycol, Olefin E1010 (made by Nisshin Chemical Industry Co., Ltd.), and deionized water were prepared, added and mixed and agitated so as to achieve a prescribed weight ratio (mass ratio). Finally, once prepared, the ink was filtered through an acetyl cellulose membrane filter having an average hole size of 0.5 μm (made by FUJIFILM Corporation), thereby removing large coarse particles. In the method described above, the ultrasonic homogenizer irradiation time was 30 minutes and the ultrasonic wave irradiation energy density was 110 W/cm², but 10 different pigment dispersions having different particle size distributions were prepared respectively as ink a, ink b, ink c, ink d, ink e, ink f, ink g, ink h, ink i, ink j, by setting the irradiation time and the irradiation energy respectively to (10 minutes, 55 W/cm²), (20 minutes, 55 W/cm²), (30 minutes, 55 W/cm²), (40 minutes, 55 W/cm²), (50 minutes, 55 W/cm²), (10 minutes, 110 W/cm²), (20 minutes, 110 W/cm²), (30 minutes, 110 W/cm²), (40 minutes, 110 W/cm²) and (50 minutes, 110 W/cm²).

The electrical conductivity of the ink was 7 mS/cm.

The particle size was measured by using a particle size distribution meter (Nanotrac UPA-EX150 made by Nikkiso Co., Ltd.). This particle size distribution analyzer uses a measurement principle known as dynamic light scattering. If the particles have a diameter equal to or less than several μm, then a Brownian motion of the particles is produced, due to the effects of the movement of the solvent molecules. The speed of this motion varies with the size of the particles: the smaller the particles, the faster they move, and the larger the particles, the slower they move. When laser light is radiated onto these particles in motion, scattering of light of different phases occurs in accordance with the speed of the particles, and when the scattered light is spectrally analyzed (spectroscopy of the scattered light is carried out), a Doppler shift is obtained. In this way, the dynamic light scattering method determines the particle size distribution by calculating the Doppler-shifted particle size information. In the particle size distribution measurement of the solvent-insoluble material, measurement is always made in transparent mode based on an aspherical shape.

The determination of the remaining amount was started in a state where the subsidiary ink container was filled with ink, and the maximum current I₀ immediately after the start of determination, the maximum current value I₁ after one day, and the maximum current value I₂ after one week, were determined.

During the determination of the remaining amount, the nozzle opening surface was capped, and furthermore, the ink supply valve and the evacuation valve were closed, so as to prevent inflow or outflow of ink to or from the subsidiary ink container, and to prevent drying. Furthermore, neither driving of the recording head nor the ink supply operations was carried out.

The ratios of the maximum current value I₁ after one day and the maximum current value I₂ after one week with respect to the maximum current I₀ immediately after the start of determination of the remaining amount of ink were derived as a=(I₁/I₀)×100%, β=(I₂/I₀)×100%, and the change in the determination capability according to the conditions was evaluated. The result of this evaluation was “very good” if both a and β are equal to or greater than 98%; the result of this evaluation was “good” if a and β are equal to or greater 95% and less than 98%; the result of this evaluation was “average” if a and β are equal to or greater than 90% and less than 95%; and the result of this evaluation was “poor” if a and β are less than 90%.

The results of the evaluation according to various conditions are shown in Table 1.

TABLE 1

| | | | Ratio of particles | Ratio of particles | | |
|---|---|---|---|---|---|---|
| | | Average | of particle | of particle | Evaluation | Evaluation |
| Determination | | particle size | size 100 nm or | size 90 nm | results after | results after |
| voltage | Ink | (nm) | greater (%) | or greater (%) | one day | one week |
| 1 V | a (Present | 46 | 1.1 | 1.5 | very good | very good |
| | invention) | | | | | |
| | b (Present | 50 | 2.3 | 3.2 | very good | very good |
| | invention) | | | | | |
| | c (Present | 60 | 2.6 | 3.9 | very good | very good |
| | invention) | | | | | |
| | d (Present | 62 | 4.6 | 4.8 | very good | very good |
| | invention) | | | | | |
| | e (Present | 52 | 4.8 | 10.2 | very good | good |
| | invention) | | | | | |
| | f (Comparative | 59 | 7.4 | 18.9 | poor | poor |
| | Example) | | | | | |
| | g (Present | 61 | 4.6 | 8.9 | very good | good |
| | invention) | | | | | |
| | h (Comparative | 76 | 19.8 | 35.6 | poor | poor |
| | Example) | | | | | |
| | i (Comparative | 82 | 37.9 | 50.4 | poor | poor |
| | Example) | | | | | |
| | j (Comparative | 95 | 52.6 | 70.5 | poor | poor |
| | Example) | | | | | |
| 3 V | a (Present | 46 | 1.1 | 1.5 | very good | very good |
| | invention) | | | | | |
| | b (Present | 50 | 2.3 | 3.2 | very good | very good |
| | invention) | | | | | |
| | c (Present | 60 | 2.6 | 3.9 | very good | very good |
| | invention) | | | | | |
| | d (Present | 62 | 4.6 | 4.8 | very good | very good |
| | invention) | | | | | |
| | e (Present | 52 | 4.8 | 10.2 | very good | average |
| | invention) | | | | | |
| | f (Comparative | 59 | 7.4 | 18.9 | poor | poor |
| | Example) | | | | | |
| | g (Present | 61 | 4.6 | 8.9 | very good | good |
| | invention) | | | | | |
| | h (Comparative | 76 | 19.8 | 35.6 | poor | poor |
| | Example) | | | | | |
| | i (Comparative | 82 | 37.9 | 50.4 | poor | poor |
| | Example) | | | | | |
| | j (Comparative | 95 | 52.6 | 70.5 | poor | poor |
| | Example) | | | | | |
| 5 V | a (Present | 46 | 1.1 | 1.5 | very good | very good |
| | invention) | | | | | |
| | b (Present | 50 | 2.3 | 3.2 | very good | very good |
| | invention) | | | | | |
| | c (Present | 60 | 2.6 | 3.9 | very good | very good |
| | invention) | | | | | |
| | d (Present | 62 | 4.6 | 4.8 | very good | very good |
| | invention) | | | | | |
| | e (Present | 52 | 4.8 | 10.2 | very good | good |
| | invention) | | | | | |
| | f (Comparative | 59 | 7.4 | 18.9 | poor | poor |
| | Example) | | | | | |
| | g (Present | 61 | 4.6 | 8.9 | very good | average |
| | invention) | | | | | |
| | h (Comparative | 76 | 19.8 | 35.6 | poor | poor |
| | Example) | | | | | |
| | i (Comparative | 82 | 37.9 | 50.4 | poor | poor |
| | Example) | | | | | |
| | j (Comparative | 95 | 52.6 | 70.5 | poor | poor |
| | Example) | | | | | |

As shown in Table 1, in the inks (a, b, c, d) which have a ratio of 5 vol % or less of particles having a particle size equal to or greater than 90 nm, it was confirmed that even after one week had passed, there was no change in the determination capability and stable determination could be carried out.

Moreover, in the inks (e and g) which have a ratio of 5 vol % or less of particles having a particle size equal to or greater than 100 nm, it was confirmed that even after one week had elapsed, there was virtually no change in the determination capability and stable determination was carried out.

Furthermore, as shown in Table 1, it was confirmed that even if the average particle size is small, in the case of an ink (f) where the ratio of particles having a particle size equal to or greater than 100 nm is 5 vol % or above, the determination capability declines markedly. Consequently, it was confirmed that the determination capability declines when the concentration of particles having a certain size or greater becomes high, regardless of the average particle size.

Ink was also introduced separately into a sealed container, set to an environmental temperature of 25° C., and the particle size was measured after one day and after one week. No change was observed in the average particle size, and it was confirmed that the inherent dispersion stability of the ink is high.

Furthermore, as shown in Table 1, it was confirmed that virtually no change occurs in the determination capability with change in the determination voltage.

Consequently, it was confirmed that, in order to enable highly reliable determination of the remaining amount of ink over a long period of time, the ink used should have a ratio of 5 vol % or less of particles having a particle size equal to or greater than 100 nm, and desirably, the ink used should have a ratio of 5 vol % or less of particles having a particle size equal to or greater than 90 nm.

In this way, it was determined that the determination accuracy declines if large and coarse particles are mixed into the ink, and it is considered that one reason for this is adherence of particles to the electrodes. In actual practice, after carrying out the investigation described above, marked adherence of particles was observed on the electrodes where the determination accuracy had declined markedly.

It is thought that the adherence of particles can be explained by migration of the particles. Under an electric field, the particles receive an electrostatic force, and a Stokes's drag in the opposite direction to the particle migration, due to the application of an electric field to the electrodes. The electrostatic force is given by F=qE (q: particle charge; E: intensity of electric field), whereas the Stokes's drag is given by F=C_{D}·½ρV²S (C_{D}: drag coefficient (a value of 0.47, in the case of a sphere and low Re); V: migration speed; S: reference surface area). If the particle charge per unit volume is uniform, then the greater the particle size, the greater the electrostatic force, and therefore the faster the speed of migration. It is thought that the particles which become attached to the electrodes as a result of migration of the particles inhibit the determination of the solvent.

It is also thought that electrostatic induction is an additional reason why the particles adhere to the electrodes. If an electrical charge is placed close to a conductor, an electrical charge having the opposite electric charge is induced on the surface of the conductor (which is also referred to as a mirror image effect). The force of attraction received by the electrical charge from the surface of the conductor is expressed by the equation F=q²/(16pel²) (1:interval between electrode and particle), and it has a value which is related to the particle size.

The average speed of migration of the solvent-insoluble material is not less than 1 μm V⁻¹s⁻¹cm, and not more than 5 μm V⁻¹s⁻¹cm, the average zeta potential of the solvent-insoluble material is not less than −60 mV and not more than −10 mV, and apart from this the ink itself is considered to undergo modification due to the flow of current, but since there was no change in the electrical conductivity after measurement then this does not provide an adequate explanation.

In measurements carried out thus far, the overall concentration of particles was 10 wt %. The effects of the particle concentration were investigated by altering the particle concentration from 0.1 wt % to 20 wt % at a determination voltage of 5V.

The results of the evaluation according to various conditions are shown in Table 2.

TABLE 2

| | | | Ratio of particles | Ratio of | | | |
|---|---|---|---|---|---|---|---|
| | | Average | of particle | particles of | Overall | Evaluation | Evaluation |
| | | particle | size 100 nm | particle size | particle | results | results |
| Determination | | size | or greater | 90 nm or | density | after one | after one |
| voltage | Ink | (nm) | (%) | greater (%) | (wt %) | day | week |
| 5 V | d | 62 | 4.6 | 4.8 | 0.1 | very good | very good |
| | (Present | | | | 0.5 | very good | very good |
| | invention) | | | | 1.0 | very good | very good |
| | | | | | 5.0 | very good | very good |
| | | | | | 10 | very good | very good |
| | | | | | 20 | very good | very good |
| | f | 59 | 7.4 | 18.9 | 0.1 | average | average |
| | (Comparative | | | | 0.5 | average | average |
| | Example) | | | | 1.0 | poor | poor |
| | | | | | 5.0 | poor | poor |
| | | | | | 10 | poor | poor |
| | | | | | 20 | poor | poor |

As shown in Table 2, it was confirmed that if the particle concentration is 1 wt % or above, then the determination accuracy is uniform, regardless of the density. Consequently, it was confirmed that the particle concentration does not have a significant effect, unless the ink is extremely diluted.

In the case of an ink having a high density of large particles, if electrical determination is carried out continuously over a long period of time, then the remaining amount of ink determination accuracy declines. In order to prevent this, it is effective to combine with a method which determines the remaining amount of ink by means of calculation, and hence the frequency at which electrical determination is carried out can be reduced.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An inkjet recording apparatus comprising:
an ink liquid container which stores ink containing a solvent-insoluble material dispersed in a solvent;
an ink supply channel which is connected to the ink liquid container; and
a pair of electrodes which is provided in the ink liquid container and/or the ink supply channel, and between which a voltage is applied so that a remaining amount of the ink in the ink liquid container and/or the ink supply channel is evaluated,
wherein ratio of particles having a particle size equal to or greater than 100 nm in the ink is 5 volume percent or less.

2. An inkjet recording apparatus comprising:
an ink liquid container which stores ink containing a solvent-insoluble material dispersed in a solvent;
an ink supply channel which is connected to the ink liquid container; and
a pair of electrodes which is provided in the ink liquid container and/or the ink supply channel, and between which a voltage is applied so that a remaining amount of the ink in the ink liquid container and/or the ink supply channel is evaluated,
wherein ratio of particles having a particle size equal to or greater than 90 nm in the ink is 5 volume percent or less.

3. The inkjet recording apparatus as defined in claim 1, wherein the solvent-insoluble material is pigment.

4. The inkjet recording apparatus as defined in claim 2, wherein the solvent-insoluble material is pigment.

5. The inkjet recording apparatus as defined in claim 1, wherein the solvent-insoluble material is latex.

6. The inkjet recording apparatus as defined in claim 2, wherein the solvent-insoluble material is latex.

7. The inkjet recording apparatus as defined in claim 1, wherein electrical conductivity of the ink is equal to or greater than 1 mS/cm.

8. The inkjet recording apparatus as defined in claim 2, wherein electrical conductivity of the ink is equal to or greater than 1 mS/cm.

9. The inkjet recording apparatus as defined in claim 1, wherein:
the ink liquid container is a main ink container from which the ink is supplied to a subsidiary ink container via the ink supply channel; and
the ink is supplied from the subsidiary ink container to a recording head.

10. The inkjet recording apparatus as defined in claim 2, wherein:
the ink liquid container is a main ink container from which the ink is supplied to a subsidiary ink container via the ink supply channel; and
the ink is supplied from the subsidiary ink container to a recording head.

11. The inkjet recording apparatus as defined in claim 1, wherein:
the ink liquid container is a subsidiary ink container to which the ink is supplied from a main ink container via the ink supply channel; and
the ink is supplied from the subsidiary ink container to a recording head.

12. The inkjet recording apparatus as defined in claim 2, wherein:
the ink liquid container is a subsidiary ink container to which the ink is supplied from a main ink container via the ink supply channel; and
the ink is supplied from the subsidiary ink container to a recording head.

13. The inkjet recording apparatus as defined in claim 1, wherein:
the ink liquid container is a main ink container from which the ink is supplied to a subsidiary ink container via the ink supply channel;
the ink is supplied from the subsidiary ink container to a recording head; and
the pair of the electrodes is provided in the main ink container so that the remaining amount of the ink in the main ink container is evaluated.

14. The inkjet recording apparatus as defined in claim 2, wherein:
the ink liquid container is a main ink container from which the ink is supplied to a subsidiary ink container via the ink supply channel;
the ink is supplied from the subsidiary ink container to a recording head; and
the pair of the electrodes is provided in the main ink container so that the remaining amount of the ink in the main ink container is evaluated.

15. The inkjet recording apparatus as defined in claim 1, wherein:
the ink liquid container is a subsidiary ink container to which the ink is supplied from a main ink container via the ink supply channel;
the ink is supplied from the subsidiary ink container to a recording head; and
the pair of the electrodes is provided in the subsidiary ink container so that the remaining amount of the ink in the subsidiary ink container is evaluated.

16. The inkjet recording apparatus as defined in claim 2, wherein:
the ink liquid container is a subsidiary ink container to which the ink is supplied from a main ink container via the ink supply channel;
the ink is supplied from the subsidiary ink container to a recording head; and
the pair of the electrodes is provided in the subsidiary ink container so that the remaining amount of the ink in the subsidiary ink container is evaluated.
